(19) United States
(12) Patent Application Publication
(10) Pub. No.: US 2012/0096495 A1
(43) Pub. Date: Apr. 19, 2012

(54) BROADCAST RECEPTION DEVICE, BROADCAST RECEPTION METHOD, AND BROADCAST TRANSMISSION DEVICE

(75) Inventor: Shigeki Matsunaga, Hyogo (JP)

(73) Assignee: PANASONIC CORPORATION, Osaka (JP)

(21) Appl. No.: 13/379,818

(22) PCT Filed: Jul. 6, 2010
(86) PCT No.: PCT/JP2010/004410

§ 371 Date: Dec. 21, 2011

(30) Foreign Application Priority Data
Jul. 13, 2009 (JP) 2009-164750

(51) Int. Cl. H04N 5/445; H04N 21/462

(52) U.S. Cl. 725/39

(57) ABSTRACT

A receiver in a broadcast receiving apparatus receives a broadcast signal including a content of a program and download control information corresponding to the program. A TLV demultiplexer separates the content of the program and the download control information from the received broadcast signal. A content storage and an ECG storage respectively store the separated content and download control information. A download processor acquires, when a missing portion exists in the stored content, a portion, which corresponds to the missing portion, of the content as a complementary portion from a distribution server by a communication unit accessing the distribution server in a distribution period represented by distribution schedule information included in the download control information. A coupler complements the missing portion of the content using the acquired complementary portion.

### TECHNICAL FIELD

The present invention relates to a broadcast receiving apparatus that receives a broadcast signal and a broadcast receiving method, and a broadcast transmitting apparatus that transmits a broadcast signal.

### BACKGROUND ART

Various broadcast receiving apparatuses and broadcast receiving systems for receiving digital broadcasting have been developed. A broadcast receiving apparatus discussed in Patent Document 1 is configured to be switchable between a broadcast receiving mode for receiving digital information relating to a program in digital broadcasting from a broadcast station and a broadcast receiving mode for receiving digital information relating to a program in digital broadcasting from a content server. The broadcast station transmits the digital information in the digital broadcasting via a broadcast channel. When there occur situations where the receiving of the digital information is interrupted while the digital information is being received from the broadcast station, digital information relating to the same program is received from a content server. Even if there occur situations where the digital information is difficult to receive, therefore, a user can view the program.
[Patent Document 1] JP 2004-40380 A

### SUMMARY OF INVENTION

### Technical Problem

Digital broadcasting includes real-time broadcasting intended for a user to view a program in real time, for example, conventional analog television broadcasting and download broadcasting intended for a user to reproduce and view a content of a program stored once in a recording medium in a broadcast receiving apparatus at a desired time.

A wide transmission band is required to transmit a content at a high bit rate as in super high definition television broadcasting and 4K2K broadcasting (broadcasting in which video composed of 4000×2000 pixels can be displayed). Therefore, such a content at a high bit rate is difficult to broadcast in real time. The download broadcasting enables the user to previously download the content at the high bit rate in the broadcast receiving apparatus and view the content at a desired time. The download broadcasting also enables a service for distributing a plurality of contents at a low bit rate having a low image quality in a shorter time than the real time.

A system for the download broadcasting includes network-type download broadcasting using an IP (Internet Protocol) network as a transmission path and broadcast-type download broadcasting using a satellite broadcast wave as a transmission path.

In the network-type download broadcasting, each of files composing a content of a program is exposed on a Web (World Wide Web) server. A broadcast receiving apparatus acquires the content of the program in file units at desired timing, and stores the acquired content in a recording medium.

On the other hand, in the broadcast-type download broadcasting, all files composing a content of a program are multiplexed on a broadcast signal, and the broadcast signal is superimposed on a broadcast wave and transmitted during a broadcast time of the program. A broadcast receiving apparatus separates the content from the broadcast signal received during the broadcast time of the program based on a reservation operation of a user, and stores the content in a recording medium.

In the broadcast-type download broadcasting, the content of the program is thus downloaded in the broadcast receiving apparatus during the broadcast time of the program. When defective receiving of the broadcast wave occurs due to rainfall during the broadcast time, therefore, a part of the content to be downloaded may be missing. Even when program scheduling is changed during the broadcast time, a part of the content to be downloaded may be missing. Further, program scheduling on any one of a plurality of channels is changed while contents on the plurality of channels are continuously downloaded so that some of the contents may be missing.

In order to complement the missing portion of the content, it is considered that a content of the same program is acquired from the content server, as in the broadcast receiving apparatus discussed in Patent Document 1. In the digital broadcast receiving apparatus discussed in Patent Document 1, if a content of the same program as the program in the broadcast-type download broadcasting is not stored in the content server during the broadcast time of the program in the broadcast-type download broadcasting, however, a missing portion of the content cannot be acquired. The content of the same program as the program in the broadcast-type download broadcasting is not easy to always store during the broadcast time of the program in the broadcast-type download broadcasting. Therefore, the possibility that the missing portion of the content can be complemented is low.

### Solution to Problem

An object of the present invention is to provide a broadcast receiving apparatus, a broadcast receiving method, and a broadcast transmitting apparatus capable of increasing the possibility that a missing portion of a content in broadcast-type download broadcasting can be complemented.

(1) According to an aspect of the present invention, a broadcast receiving apparatus is configured to be capable of receiving a broadcast signal in broadcast-type download broadcasting while being connectable to a distribution server that stores a content of a program, including a receiver that receives a broadcast signal including the content of the program and download control information corresponding to the program, a separator that separates the content of the program and the download control information from the broadcast signal received by the receiver, a storage that stores the content and the download control information separated by the separator, a communication unit that can access the distribution server, and a complementer that acquires, when a missing portion exists in the content stored in the storage, a portion, which corresponds to the missing portion, of the content as a complementary portion from the distribution server by the communication unit accessing the distribution server, and complements the missing portion of the content using the acquired complementary portion, in which the download control information includes distribution schedule information representing a distribution period of the content by the distribution server, and the complementer controls the communication unit to acquire the complementary portion corresponding to the missing portion in the distribution period represented by the distribution schedule information included in the download control information.

In the broadcast receiving apparatus, the receiver receives the broadcast signal including the content of the program and the download control information corresponding to the program. The separator separates the content of the program and the download control information from the received broadcast signal. The storage stores the separated content and download control information. If the missing portion exists in the stored content, the complementer acquires as the complementary portion a portion, which corresponds to the missing portion, of the content from the distribution server by the communication unit accessing the distribution server in the distribution period represented by the distribution schedule information included in the download control information.

Thus, the complementary portion of the content is acquired from the distribution server in the period during which the content of the same program as the program in the broadcast-type download broadcasting is distributed based on the distribution schedule information. This enables the possibility that the missing portion of the content in the broadcast-type download broadcasting can be complemented to be increased.

(2) The complementer may couple the complementary portion acquired from the distribution server to the missing portion of the content stored in the storage, to complement the missing portion of the content.

In this case, a user of the broadcast receiving apparatus can view the content having no missing portion.

(3) The content stored in the storage may include a plurality of packets, the complementer may acquire one or a plurality of packets corresponding to one or a plurality of packets including the missing portion as a complementary portion from the distribution server by the communication unit, and replace the one or plurality of packets including the missing portion with the acquired one or plurality of packets, to complement the missing portion of the content.

In this case, a range of the missing portion of the content can be easily designated while the packet including the complementary portion can be easily acquired. The packet including the missing portion is replaced with the packet including the complementary portion so that the missing portion of the content can be easily complemented. Thus, the algorithm for complementing the missing portion of the content can be simplified.

(4) The download control information may further include broadcast schedule information representing a broadcast time of a program in the broadcast-type download broadcasting, and the complementer may determine, when the storage of the content of the program in the storage is not completed within the broadcast time represented by the broadcast schedule information, a portion, which is not stored as the missing portion.

In this case, the portion, which is not stored, of the content of the program, can be easily determined to be the missing portion within the broadcast time of the program in the broadcast-type download broadcasting based on the broadcast schedule information. Thus, the portion, which corresponds to the missing portion, of the content can be acquired as the complementary portion from the distribution server after the program in the broadcast-type download broadcasting finishes being broadcast. As a result, if the size of the content of the program in the broadcast-type download broadcasting is large, or if the transfer rate of the broadcast signal is low, the whole of the content in the broadcast-type download broadcasting can be stored in the storage.

(5) The download control information may further include acquisition content information stored in the storage to respectively correspond to a plurality of portions of the content stored in the storage and each representing a position of a corresponding portion in the content and the size of the content, and the complementer may determine whether the portion, which is not stored in the storage, of the content exists based on the acquisition content information included in the download control information at the time point where the program in the broadcast-type download broadcasting finishes being broadcast, and determine, when the portion, which is not stored in the storage, exists, the portion that is not stored in the storage as the missing portion.

In this case, the portion, which is not stored, of the content can be easily determined to be the missing portion at the time point where the program in the broadcast-type download broadcasting finishes being broadcast based on the acquisition content information. Even when a part of the content is not stored within the broadcast time of the program, therefore, the complementary portion, which corresponds to the missing portion, of the content can be acquired from the distribution server after the program finishes being broadcast so that the missing portion of the content can be complemented.

(6) The complementer may determine, when a value of the position of the corresponding portion in the content is smaller than a value of the size of the content at the time point where the program in the broadcast-type download broadcasting finishes being broadcast, a region from the position of the corresponding portion in the content to a final portion of the content as the missing portion.

In this case, it can be easily determined whether the whole of the content is stored at the time point where the program in the broadcast-type download broadcasting finishes being broadcast. The portion, which is not stored, of the content can be easily determined.

(7) According to another aspect of the present invention, a broadcast receiving method includes the steps of receiving a broadcast signal including a content of a program and download control information corresponding to the program, separating the content of the program and the download control information from the received broadcast signal, storing the separated content and download control information, accessing a distribution server storing the content of the program when a missing portion exists in the stored content, to acquire a portion, which corresponds to the missing portion, of the content as a complementary portion from the distribution server, and complementing the missing portion of the content using the acquired complementary portion, in which the download control information includes distribution schedule information representing a distribution period of the content by the distribution server, and the acquiring step includes the step of acquiring the complementary portion corresponding to the missing portion in the distribution period represented by the distribution schedule information included in the download control information.

In the broadcast receiving method, the broadcast signal including the content of the program and the download control information corresponding to the program is received. The content of the program and the download control information are separated from the received broadcast signal. The separated content and download control information are stored. If the missing portion exists in the stored content, the portion, which corresponds to the missing portion, of the content is acquired as the complementary portion from the distribution server by accessing the distribution server in the distribution period represented by the distribution schedule information included in the download control information.

Thus, the complementary portion of the content is acquired from the distribution server in the period during which the content of the same program as the program in the broadcast-type download broadcasting is distributed based on the distribution schedule information. This enables the possibility that the missing portion of the content in the broadcast-type download broadcasting can be complemented to be increased.

(8) The storing step may include the step of storing a content including a plurality of packets, the acquiring step may include the step of acquiring one or a plurality of packets corresponding to one or a plurality of packets including the missing portion as a complementary portion from the distribution server, and the complementing step may include the step of replacing the one or plurality of packets including the missing portion with the acquired one or plurality of packets, to complement the missing portion of the content.

In this case, the range of the missing portion of the content can be easily designated while the packet including the complementary portion can be easily acquired. The packet including the missing portion is replaced with the packet including the complementary portion so that the missing portion of the content can be easily complemented. Thus, the algorithm for complementing the missing portion of the content can be simplified.

(9) The download control information may further include broadcast schedule information representing a broadcast time of a program in broadcast-type download broadcasting, and the complementing step may include the step of determining, when the storage of the content of the program is not completed within the broadcast time represented by the broadcast schedule information, the portion that is not stored as the missing portion.

In this case, the portion, which is not stored, of the content of the program can be easily determined to be the missing portion within the broadcast time of the program in the broadcast-type download broadcasting based on the broadcast schedule information. Thus, the portion, which corresponds to the missing portion, of the content can be acquired as the complementary portion from the distribution server after the program in the broadcast-type download broadcasting finishes being broadcast. As a result, if the size of the content of the program in the broadcast-type download broadcasting is large, or if the transfer rate of the broadcast signal is low, the whole of the content in the broadcast-type download broadcasting can be stored.

(10) The download control information may further include acquisition content information stored to respectively correspond to a plurality of portions of the stored content and each representing a position of the corresponding portion in the content and the size of the content, and the method may further include the step of determining whether the portion, which is not stored, of the content exists based on the acquisition content information included in the download control information at the time point where the program in the broadcast-type download broadcasting finishes being broadcast, and determining, when the portion, which is not stored, exists, the portion that is not stored as the missing portion.

In this case, the portion, which is not stored, of the content can be easily determined to be the missing portion at the time point where the program in the broadcast-type download broadcasting finishes being broadcast based on the acquisition content information. Even if a part of the content is not stored within the broadcast time of the program, therefore, the complementary portion, which corresponds to the missing portion, of the content is acquired from the distribution server so that the missing portion of the content can be complemented after the program finishes being broadcast.

(11) The acquiring step may include the step of determining, when a value of the position of the corresponding portion in the content is smaller than a value of the size of the content at the time point where the program in the broadcast-type download broadcasting finishes being broadcast, a region from a position of the corresponding portion in the content to a final portion of the content as the missing portion.

In this case, it can be easily determined whether the whole of the content is stored at the time point where the program in the broadcast-type download broadcasting finishes being broadcast. The portion, which is not stored, of the content can be easily determined.

(12) According to still another aspect of the present invention, a broadcast transmitting apparatus that transmits a broadcast signal in broadcast-type download broadcasting includes a multiplexer that multiplexes a content of a program and download control information corresponding to the program on the broadcast signal, and a transmitter that transmits the broadcast signal after the multiplexing by the multiplexer, in which the download control information includes distribution schedule information representing a distribution period of the content by a distribution server storing the content of the program.

In the broadcast receiving apparatus, the multiplexer multiplexes the content of the program and the download control information corresponding to the program on the broadcast signal. The transmitter transmits the broadcast signal after the multiplexing by the multiplexer. The download control information includes the distribution schedule information representing the distribution period of the content by the distribution server storing the content of the program.

In this case, the broadcast receiving apparatus that receives the broadcast signal transmitted from the broadcast transmitting apparatus can acquire the portion, which corresponds to the missing portion, of the content as the complementary portion from the distribution server in the period during which the content of the same program as the program in the broadcast-type download broadcasting is distributed based on the distribution schedule information. This enables the possibility that the missing portion of the content in the broadcast-type download broadcasting can be complemented in the broadcast receiving apparatus to be increased.

### Advantageous Effects of Invention

According to the present invention, the possibility that a missing portion of a content in broadcast-download broadcasting can be complemented to be increased.

### BRIEF DESCRIPTION OF DRAWINGS

FIG. 1 is a block diagram illustrating a configuration of a broadcast transmitting and receiving system according to an embodiment of the present invention.

FIG. 2 is a diagram illustrating a configuration of a reproduction control information file.

FIG. 3 is a diagram illustrating a configuration of an ECG data file.

FIG. 4 is a diagram for illustrating broadcast schedule information and distribution schedule information illustrated in FIG. 3.

FIG. 5 is a flowchart illustrating download processing for a download program in a broadcast receiving apparatus illustrated in FIG. 1.

FIG. 6 is a diagram for illustrating a missing portion and a complementary portion of a content.

FIG. 7 is a flowchart illustrating complementary processing for a missing portion of a content in a broadcast receiving apparatus illustrated in FIG. 1.

FIG. 8 is a diagram for illustrating a missing portion, missing information, and a complementary portion of a content in a second embodiment.

FIG. 9 is a diagram for illustrating content information illustrated in FIG. 3.

FIG. 10 is a flowchart illustrating complementary processing for a missing portion of a content in a broadcast receiving apparatus according to a third embodiment.

FIG. 11 is a flowchart illustrating complementary processing for a missing portion of a content in the broadcast receiving apparatus according to the third embodiment.

### DESCRIPTION OF EMBODIMENTS

### [1] First Embodiment

A broadcast transmitting and receiving system according to a first embodiment will be described below with reference to the drawings.

(1) Broadcast Transmitting and Receiving Apparatus

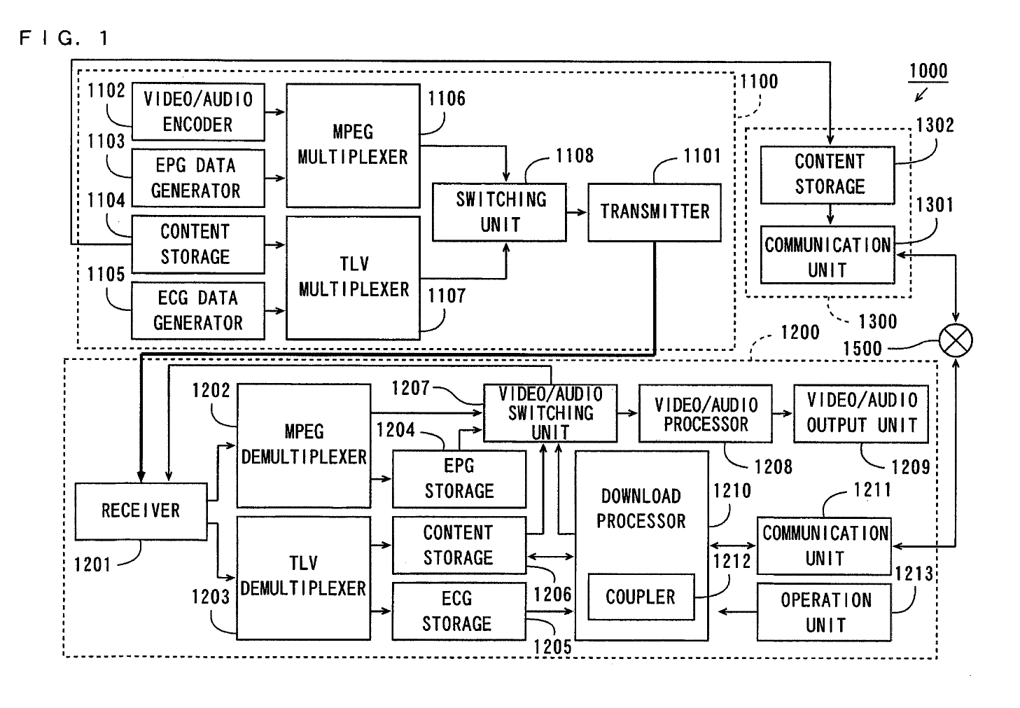

FIG. 1 is a block diagram illustrating a configuration of a broadcast transmitting and receiving system according to an embodiment of the present invention. As illustrated in FIG. 1, a broadcast transmitting and receiving system 1000 includes a broadcast transmitting apparatus 1100, a broadcast receiving apparatus 1200, and a distribution server 1300. The broadcast transmitting and receiving system 1000 illustrated in FIG. 1 is adapted to advanced BS (Broadcasting Satellite) digital broadcasting.

The broadcast transmitting apparatus 1100 can perform real-time broadcasting while performing broadcast-type download broadcasting. The broadcast receiving apparatus 1200 can receive a content of a program provided by the real-time broadcasting while receiving a content of a program provided by the broadcast-type download broadcasting.

The program provided by the real-time broadcasting is hereinafter referred to as a real-time program, and the program provided by the broadcast-type download broadcasting is referred to as a download program. Details of the download program will be described below. The broadcast-type download broadcasting can be operated by an advanced satellite broadcast standard such as an ISDB-S (Integrated Services Digital Broadcasting-Satellite).

The broadcast transmitting apparatus 1100 includes a transmitter 1101, a video/audio encoder 1102, an EPG (Electronic Program Guide) data generator 1103, a content storage 1104, an ECG (Electronic Contents Guide) data generator 1105, an MPEG (Moving Picture Experts Group) multiplexer 1106, a TLV (Type Length Value) multiplexer 1107, and a switching unit 1108.

The video/audio encoder 1102 encodes video data, audio data, and caption data that constitute a content of the real time program according to MPEG-2 data. The EPG data generator 1103 generates real time programs simultaneously broadcast and an electronic program guide representing broadcast schedules of the real time programs as EPG data. The MPEG multiplexer 1106 multiplexes the content encoded by the video/audio encoder 1102 and the EPG data generated by the EPG data generator 1103 on a transport stream conforming to MPEG-2 (hereinafter referred to as an MPEG-TS). The EPG data is described as SI (Service Information) on a PMT (Program Map Table) of the MPEG-TS.

The content storage 1104 previously stores a content of the download program and a reproduction control information file. The content of the download program includes a media file. The media file includes video data, audio data, and caption data relating to each download program. The media file is MPEG-TS, for example. The MPEG-TS includes a plurality of fixed-length packets (hereinafter referred to as TS packets) composed of 192 bytes or 188 bytes. Each of the TS packets composing the MPEG-TS stores video data in an MPEG-2 format or an H.264 format, music data in an AAC (Adaptive Audio Coding) format or an AC3 (Audio Code Number 3) format, and caption data in a divided manner. The reproduction control information file contains information required for reproduction control of the download program. Details of the reproduction control information file will be described below.

The ECG data generator 1105 generates an electronic content guide containing detailed information relating to the download program as ECG data. Details of the ECG data will be described below. The TLV multiplier 1107 multiplexes the content and the reproduction control information file stored in the content storage 1104 and the ECG data stored in the ECG data generator 1105 on a stream conforming to a TLV multiplexing method (hereinafter referred to as a TLV stream). In the TLV multiplexing method, a variable-length packet is used to increase transmission efficiency.

The switching unit 1108 selectively feeds the MPEG-TS obtained by the MPEG multiplier 1106 and the TLV stream obtained by the TLV multiplier 1107 to the transmitter 1101 depending on a broadcast schedule. The transmitter 1101 superimposes the fed MPEG-TS or TLV stream on a broadcast wave, and transmits the broadcast wave.

The broadcast receiving apparatus 1200 includes a receiver 1201, an MPEG demultiplexer 1202, a TLV demultiplexer 1203, an EPG storage 1204, an ECG storage 1205, a content storage 1206, a video/audio switching unit 1207, a video/audio processor 1208, a video/audio output unit 1209, a download processor 1210, a communication unit 1211, and an operation unit 1213. The communication unit 1211 is connected to the Internet 1500.

The receiver 1201 receives the broadcast wave transmitted as a broadcast signal by the broadcast transmitting apparatus 1100 while tuning in to a channel. The receiver 1201 demodulates the broadcast signal on the channel that has been tuned in to, to extract the MPEG-TS or the TLV stream from the broadcast signal, feed the MPEG-TS to the MPEG demultiplexer 1202 and feed the TLV stream to the TLV demultiplexer 1203.

The MPEG demultiplexer 1202 separates the fed MPEG-TS into an AV (Audio and Visual) stream and EPG data. The AV stream includes encoded video data and audio data. The caption data is included in the video data. The EPG storage 1204 stores the EPG data separated by the MPEG demultiplexer 1202.

The TLV demultiplexer 1203 separates the fed TLV stream into an AV (Audio and Visual) stream, reproduction control information, and ECG data. The ECG storage 1205 stores the ECG data separated by the TLV demultiplexer 1203. The content storage 1206 stores the AV stream separated by the TLV demultiplexer 1203 as a content while storing the reproduction control information. The AV stream is composed of MPEG-TS, and includes encoded video data and audio data. The caption data is included in the video data.

The video/audio switching unit 1207 provides the AV stream separated by the MPEG demultiplexer 1202 or the AV stream stored in the content storage 1206 to the video/audio processor 1208 in response to a user's operation.

When the user performs an operation for viewing the real-time program, the video/audio switching unit 1207 feeds the AV stream obtained by the MPEG demultiplexer 1202 to the video/audio processor 1208. The video/audio processor 1208 decodes the AV stream into video data and audio data. The video/audio output unit 1209 includes a video display device such as a liquid crystal display device and an audio output device such as a speaker. The video/audio output unit 1209 displays video on the video display device based on the video data obtained by the video/audio processor 1208 while outputting audio from the audio output device based on the audio data. Thus, the user can view the real-time program.

The EPG data stored in the EPG storage 1204 is fed to the video/audio processor 1208 in response to a user's operation. Thus, the video/audio processor 1208 feeds video data representing the electronic program guide for the real-time program to the video/audio output unit 1209 based on the EPG data. The video/audio output unit 1209 displays the electronic program guide for the real-time program on the video display device based on the video data.

On the other hand, when the user performs an operation for viewing the download program, the video/audio switching unit 1207 feeds the AV stream stored in the content storage 1206 to the video/audio processor 1208. The video/audio processor 1208 decodes the AV stream into video data and audio data based on the reproduction control information stored in the content storage 1206. The video/audio output unit 1209 displays video on the video display device based on the video data obtained by the video/audio processor 1208 while outputting audio from the audio output device based on the audio data. Thus, the user can view the download program.

The ECG data stored in the ECG storage 1205 is fed to the video/audio processor 1208 in response to a user's operation. Thus, the video/audio processor 1208 provides video data representing an electronic content guide for the download program to the video/audio output unit 1209 based on the ECG data. The video/audio output unit 1209 displays an electronic content guide for the download program on the video display device based on the video data. The user can reserve downloading of the download program based on the electronic content guide.

The download processor 1210 includes a coupler 1212. The download processor 1210 determines whether there is a missing portion in the content stored in the content storage 1206. If the missing portion exists in the content, the download processor 1210 controls the communication unit 1211 to acquire a portion (hereinafter referred to as a complementary portion), which corresponds to the missing portion, of the content from the distribution server 1300, described below, based on the ECG data stored in the ECG storage 1205. Thus, the download processor 1210 acquires at least the missing portion of the content from the distribution server 1300 via the communication unit 1211 and the Internet 1500.

The coupler 1212 in the download processor 1210 couples the complementary portion acquired from the distribution server 1300 to the missing portion of the content stored in the content storage 1206, to complement the missing portion of the content. Even when the missing portion occurs in the content, therefore, the user can view the download program having no missing portion.

The operation unit 1213 includes a remote control, for example. The user performs an operation for viewing the real-time program and an operation for viewing the download program via the operation unit 1213. When the user operates the operation unit 1213 to reserve downloading of the download program, download processing for the download program and complementary processing for the missing portion of the content are performed. Details thereof will be described below.

The ECG storage 1205 is implemented by hardware such as a CPU (Central Processing Unit) and a memory and software such as a computer program. The content storage 1206 is implemented by a recording medium such as a hard disk or a memory. The download processor 1210 is implemented by hardware such as a CPU and software such as a computer program. The CPU in the ECG storage 1205 performs the download processing for the download program, described below, according to the computer program. The CPU in the download processor 1210 performs the complementary processing for the missing portion of the content, described below, according to the computer program. The whole or a part of the ECG storage 1205 and the download processor 1210 may be implemented by hardware such as a semiconductor integrated circuit.

The distribution server 1300 includes a communication unit 1301 and a content storage 1302. The communication unit 1301 is connected to the Internet 1500. The content storage 1302 stores the same content as the content stored in the content storage 1104 in the broadcast transmitting apparatus 1100. The communication unit 1301 transmits at least a part of the content to the broadcast receiving apparatus 1200 via the Internet 1500 in response to a request from the broadcast receiving apparatus 1200.

(2) Download Program

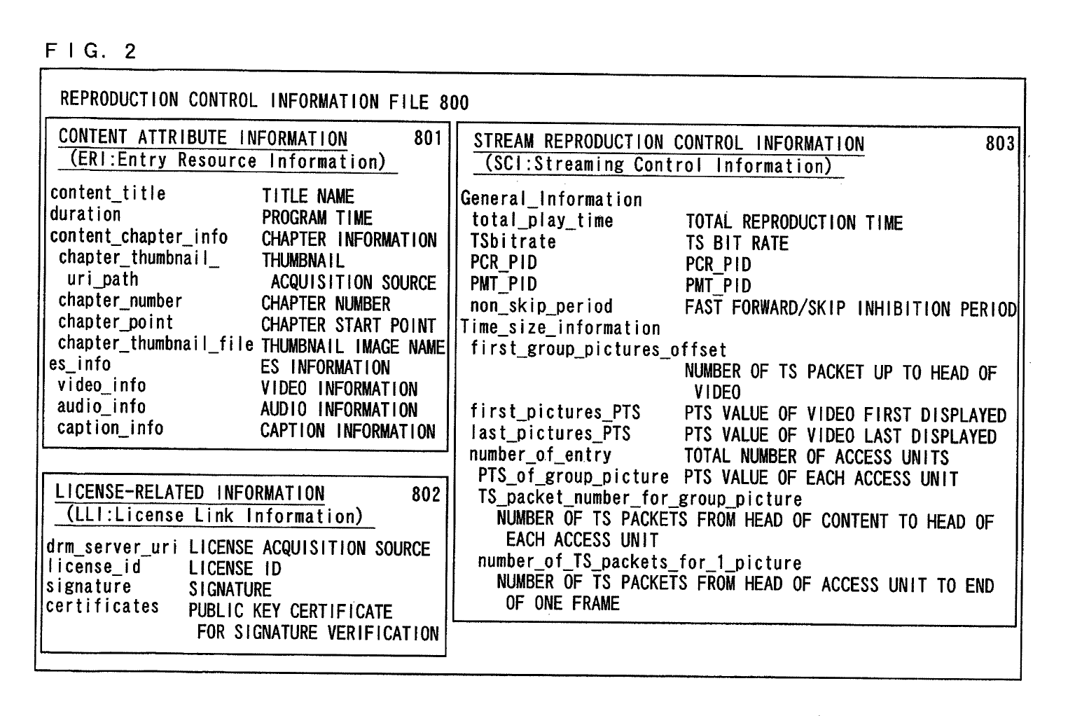

FIG. 2 is a diagram illustrating a configuration of a reproduction control information file. As illustrated in FIG. 2, the reproduction control information file 800 contains information for reproducing a download program. More specifically, the reproduction control information file 800 includes content attribute information (ERI (Entry Resource Information)) 801, license-related information (LLI (License Link Information)) 802, and stream reproduction control information (SCI (Streaming Control Information)) 803.

The content attribute information 801 contains an attribute to a content of the download program. More specifically, the content attribute information 801 includes a title name, a program time, chapter information, a thumbnail acquisition source, a chapter number, a chapter start point, a thumbnail image name, ES (Elementary Stream) information, video information, audio information, and caption information of the download program.

The license-related information 802 contains information required to reproduce a media file protected by copyright. More specifically, the license-related information 802 includes a license acquisition source, a license ID (identifier), a signature, and a public key certificate for signature verification.

The stream reproduction control information 803 contains information required to reproduce a media file. More specifically, the stream reproduction control information 803 includes a total reproduction time of the media file, a TS bit rate, a PCR (Program Clock Reference)_PID (Packet Identifier), PMT_PID, a fast forward/skip inhibition period, the number of TS packets up to the head of video, a PTS (Presentation Time Stamp) value of video first displayed, a PTS value of video last displayed, the total number of access units, a PTS value of each access unit, the number of TS packets from the head of a content to the head of each access unit, and the number of TS packets from the head of the access unit to the end of one frame.

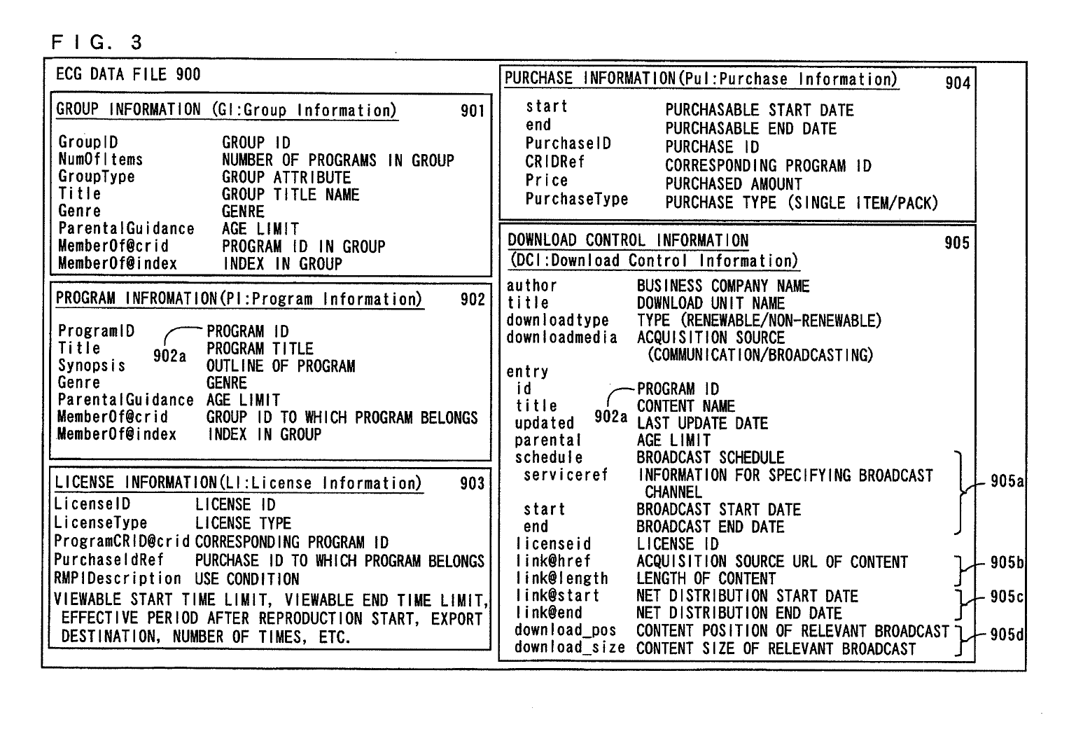

FIG. 3 is a diagram illustrating a configuration of an ECG data file. The ECG data is stored in the ECG data file for each download program. As illustrated in FIG. 3, the ECG data file 900 contains detailed information relating to the download program. More specifically, the ECG data file 900 includes group information (GI) 901, program information (PI) 902, license information (LI) 903, purchase information (PuI) 904, and download control information (DCI) 905. A plurality of download programs are classified into groups. Each of the download programs has a specific program ID 902a.

The group information 901 contains details of the group to which the download program belongs. More specifically, the group information 901 includes a group ID of the group to which the download program belongs, the number of programs in the group, an attribute to the group, a title name of the group, a genre, an age limit, a program ID 902a in the group, and an index in the group.

The program information 902 contains details of the download program. More specifically, the program information 902 includes a program ID 902a of the download program, a title of the download program, a synopsis of the download program, a genre, an age limit, an ID to which the download program belongs, and an index in the group.

The license information 903 contains details of a license of the download program. More specifically, the license information 903 includes a license ID of the download program, a license type, a corresponding program ID 902a, a purchase ID to which the download program belongs, and a use condition.

The purchase information 904 contains details of a purchase condition of the download program. More specifically, the purchase information 904 includes a purchasable start date of the download program, a purchasable end date of the download program, a purchase ID, a corresponding program ID 902a, a purchase amount, and a purchase type (a single item/pack).

The download control information 905 contains information required to download the download program. More specifically, the download control information 905 includes a name of a business company of the download program, a name of a download unit, a type (renewable/non-renewable), an acquisition source (communication/broadcasting), a program ID 902a, a content name, a last update date, an age limit, and a broadcast schedule. The download control information 905 further includes information for specifying a broadcast channel, a broadcast start date, a broadcast end date, a license ID, an acquisition source URL (Uniform Resource Locator) of the content, the length of the content, a network distribution start date, a network distribution end date, a content position of a relevant broadcast, and a content size of the relevant broadcast.

The broadcast schedule, the information for specifying a broadcast channel, the broadcast start date, and the broadcast end date are collectively referred to as broadcast schedule information 905a. A time from the broadcast start date to the broadcast end date is a broadcast time. The acquisition source URL of the content and the length of the content are collectively referred to as address information 905b. A time from the network distribution start date to the network distribution end date is collectively referred to as distribution schedule information 905c. A time from the network distribution start date to the network distribution end date is a distribution period. The content position of the relevant broadcast and the content size of the relevant broadcast are collectively referred to as content information 905d.

(3) Download Processing for Download Program

The user of the broadcast receiving apparatus 1200 according to the present embodiment can reserve downloading of a download program by operating the operation unit 1213 while referring to a program title, a broadcast channel, and a broadcast start date in the electronic content guide displayed on the video/audio output unit 1209 illustrated in FIG. 1. The download processing for the download program will be described below.

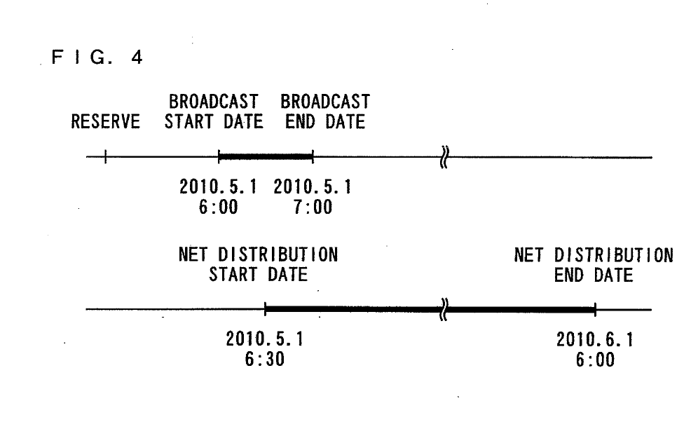

FIG. 4 is a diagram for illustrating the broadcast schedule information 905a and the distribution schedule information 905c illustrated in FIG. 3. As illustrated in FIG. 4, a case where downloading of a download program in which the broadcast start date included in the broadcast schedule information 905a is 6:00 on May 1, 2010 and the broadcast end date included therein is 7:00 on May 1, 2010 is reserved will be described as an example. In this example, the network distribution start date included in the distribution schedule information 905c relating to the download program is 6:30 on May 1, 2010, and a network distribution end date included therein is 6:00 on Jun. 1, 2010, for example.

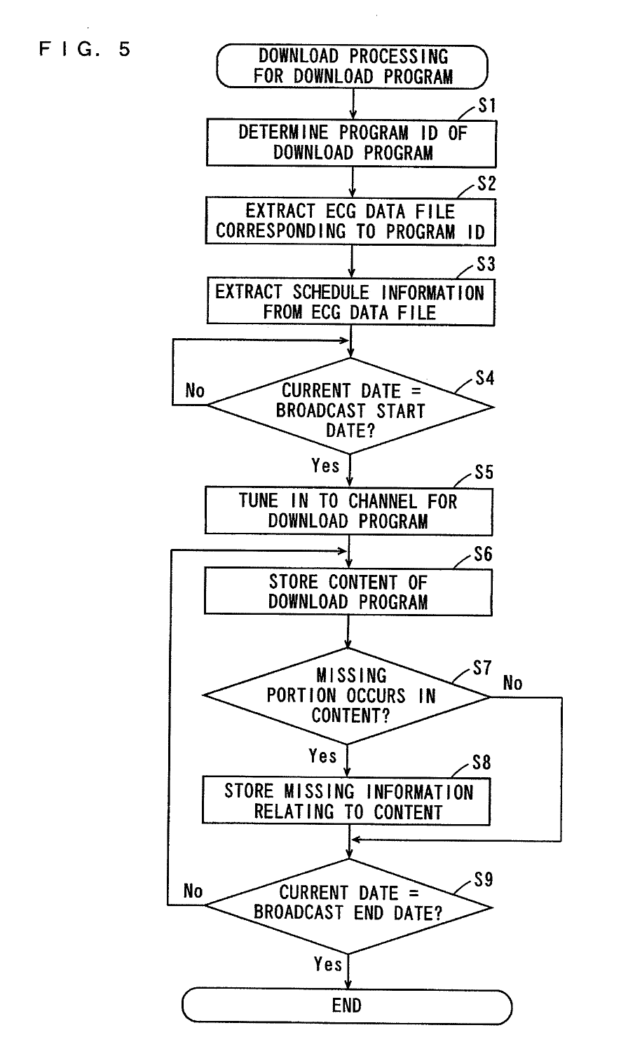

FIG. 5 is a flowchart illustrating download processing for a download program in the broadcast receiving apparatus 1200 illustrated in FIG. 1. As illustrated in FIG. 5, if the user reserves downloading of the download program, the ECG storage 1205 (see FIG. 1) in the broadcast receiving apparatus 1200 determines the program ID 902a (see FIG. 3) of the download program (step S1). The ECG storage 1205 then extracts the ECG data file 900 (see FIG. 3) corresponding to the determined program ID 902a (step S2). The ECG storage 1205 then extracts the broadcast schedule information 905a (see FIG. 3) from the ECG data file 900 (step S3).

The ECG storage 1205 compares the broadcast start date (6:00 on May 1, 2010 in this example) included in the schedule information 905a with the current date (step S4). If the current date is not the broadcast start date (6:00 on May 1, 2010 in this example), the ECG storage 1205 waits until the current date reaches the broadcast start date (6:00 on May 1, 2010 in this example). If the current date is the broadcast start date (6:00 on May 1, 2010 in this example), the ECG storage 1205 determines a broadcast channel for the download program based on information for specifying the broadcast channel included in the broadcast schedule information 905a, to control the receiver 1201 to tune in to the broadcast channel (step S5).

The ECG storage 1205 stores a content of the download program separated from the TLV stream by the TLV demultiplexer 1203 (see FIG. 1) in the content storage 1206 (see FIG. 1) (step S6). The ECG storage 1205 determines whether a missing portion occurs in the content stored in the content storage 1206 (step S7). If the missing portion does not occur in the content, the processing proceeds to step S9. If the missing portion occurs in the content, the ECG storage 1205 stores a range of the missing portion of the content as missing information in the content storage 1206 (step S8).

The ECG storage 1205 then compares the broadcast end date (7:00 on May 1, 2010 in this example) included in the broadcast schedule information 905a with the current date (step S9).

If the current date is not the broadcast end date (7:00 on May 1, 2010 in this example), the processing by the ECG storage 1205 returns to step S6. If the current date is the broadcast end date (7:00 on May 1, 2010 in this example), the ECG storage 1205 ends the download processing for the download program.

Thus, the content of the download program is stored in the content storage 1206. If one or a plurality of missing portions occur in the content, one or a plurality of missing information are sequentially stored in the content storage 1206.

(4) Complementary Processing for Missing Portion of Content

A signal level of a broadcast wave transmitted from the broadcast transmitting apparatus 1100 may be decreased until it reaches the broadcast receiving apparatus 1200 due to rainfall or the like. When a signal level of a broadcast wave received by the broadcast receiving apparatus 1200 is decreased, a missing portion may occur in a content stored in the content storage 1206 in the broadcast receiving apparatus 1200.

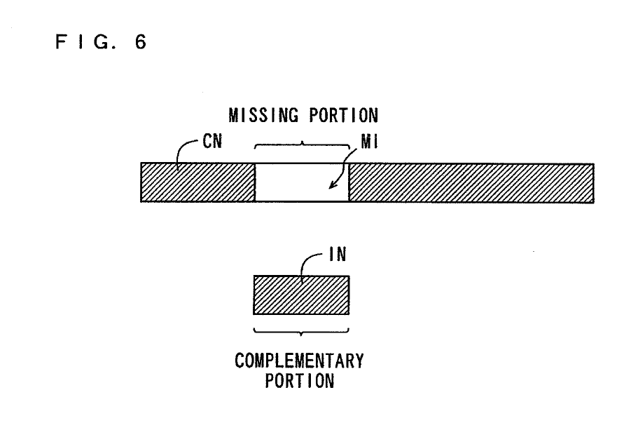

FIG. 6 is a diagram illustrating a missing portion and a complementary portion of the content. As illustrated in FIG. 6, the broadcast receiving apparatus 1200 according to the present embodiment acquires, if a missing portion MI occurs in a content CN stored in the content storage 1206 in download processing for a download program, a portion (an complementary portion IN), which corresponds to the missing portion MI, of the content, and performs complementary processing for the missing portion MI of the content CN using the acquired complementary portion IN. The complementary processing for the missing portion MI of the content CN will be described below.

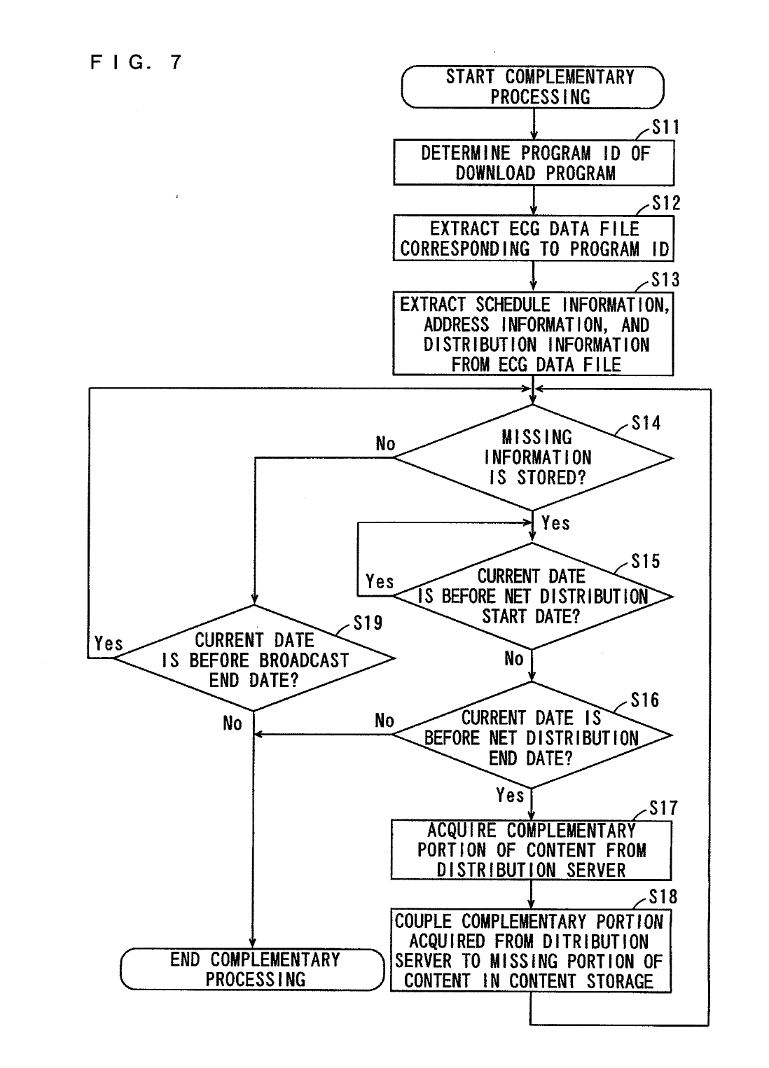

FIG. 7 is a flowchart illustrating complementary processing for a missing portion of a content in the broadcast receiving apparatus 1200 illustrated in FIG. 1. The complementary processing for the missing portion of the content may be performed concurrently with the download processing for the download program illustrated in FIG. 5, or may be performed in an available time of various types of processing of the broadcast receiving apparatus 1200 after the end of the download processing. In the present embodiment, a case where the complementary processing for the missing portion of the content is performed concurrently with the download processing for the download program will be described below.

When the user performs downloading of the download program, the download processor 1210 (see FIG. 1) in the broadcast receiving apparatus 1200 determines a program ID 902a (see FIG. 3) of the download program (step S11). The download processor 1210 then extracts the ECG data file 900 (see FIG. 3) corresponding to the program ID 902a from the ECG storage 1205 (see FIG. 1) (step S12). The download processor 1210 then extracts the broadcast schedule information 905a, the address information 905b, and the distribution schedule information 905c (see FIG. 3) from the ECG data file 900 (step S13).

The download processor 1210 then determines whether the missing information is stored in the content storage 1206 (see FIG. 1) in step S8 illustrated in FIG. 5 (step S14). If the missing information is not stored, the processing proceeds to step S19, described below. If the missing information is stored, the download processor 1210 determines whether the current date is before the network distribution start date (6:30 on May 1, 2010 in this example) included in the distribution schedule information 905c (step S15). If the current date is before the network distribution start date (6:30 on May 1, 2010 in this example), the download processor 1210 waits until the current date reaches the network distribution start date (6:30 on May 1, 2010 in this example).

If the current data is after the network distribution start date (6:30 on May 1, 2010 in this example), the download processor 1210 determines whether the current date is before the network distribution end date (6:00 on Jun. 1, 2010 in this example) included in the distribution schedule information 905c (step S16). If the current data is before the network distribution end date (6:00 on Jun. 1, 2010 in this example), the download processor 1210 accesses the distribution server 1300 (see FIG. 1) based on the extracted address information 905b, and acquires at least the complementary portion of the content from the distribution server 1300 (step S17).

More specifically, the download processor 1210 accesses the distribution server 1300 via the communication unit 1211 (see FIG. 1) and the Internet 1500 (see FIG. 1) based on the acquisition source URL of the content in the acquired address information 905b. The download processor 1210 then distributes a signal for requesting distribution of at least the complementary portion of the content (hereinafter referred to as an HTTP-Get request) to the distribution server 1300 based on the missing information by using an “HTTP-Get” protocol. The HTTP-Get request includes a distribution request start position and a distribution request size in the content. The distribution request start position and the distribution request size are set to include a portion, which corresponds to the missing portion, of the content.

The distribution server 1300 extracts, when it receives the HTTP-Get request from the broadcast receiving apparatus 1200 via the Internet 1500 and the communication unit 1301 (see FIG. 1), the complementary portion of the content requested from the content storage 1302 (see FIG. 1). The distribution server 1300 then transmits the extracted complementary portion of the content to the broadcast receiving apparatus 1200 via the communication unit 1301 and the Internet 1500. The download processor 1210 receives the complementary portion of the content from the distribution server 1300 via the Internet 1500 and the communication unit 1211. Thus, the download processor 1210 can acquire the complementary portion of the content.

The coupler 1212 (see FIG. 1) in the download processor 1210 couples the complementary portion of the content acquired from the distribution server 1300 to the missing portion of the content stored in the content storage 1206 (step S18). Thus, the missing portion of the content stored in the content storage 1206 is complemented. The processing by the download processor 1210 then returns to step S14. In step S14, the download processor 1210 determines whether another missing information is stored in the content storage 1206.

If the other missing information is stored in the content storage 1206 in step S14, the download processor 1210 determines whether the current date is before the broadcast end date (7:00 on May 1, 2010 in this example) of the download program included in the broadcast schedule information 905a (step S19). If the current date is before the broadcast end date (7:00 on May 1, 2010 in this example), the processing by the download processor 1210 returns to step S14, since new missing information may be stored in the content storage 1206 during download processing for the download program. If the current date is after the broadcast end date (7:00 on May 1, 2010 in this example), the download processor 1210 ends processing for complementing the missing portion of the content.

If a network distribution period of the content of the download program thus overlaps a broadcast period of the download program, one or a plurality of missing portions of the content are complemented using the complementary portion sequentially acquired from the distribution server 1300 based on one or a plurality of missing information sequentially stored in the content storage 1206 while the download processing for the download program is being performed. If the network distribution period of the content of the download program is after the broadcast period of the download program, one or a plurality of missing portions of the content of the download program are complemented using the complementary portion acquired from the distribution server 1300 based on the one or plurality of missing information stored in the content storage 1206 at the time point where the current date reaches the network distribution start date.

If the current date is after the network distribution end date (6:00 on Jun. 1, 2010 in this example) in step S16, the download processor 1210 cannot complement the missing portion of the content. Therefore, the download processor 1210 ends the complementary processing for the missing portion of the content. In this case, the download processor 1210 may indicate that the missing portion of the content is not complemented on the video display device in the video/audio output unit 1209 (see FIG. 1). Thus, the user of the broadcast receiving apparatus 1200 can recognize that the missing portion exists in the content.

Alternatively, if the current date is after the network distribution end date in step S16, the download processor 1210 may wait until the content of the download program is distributed again from the distribution server 1300. In this case, if the content of the download program is not distributed again from the distribution server 1300 within a predetermined period, the download processor 1210 may indicate that the missing portion of the content is not complemented on the video display device in the video/audio output unit 1209 (see FIG. 1).

(5) Effects

In the broadcast receiving apparatus 1200 according to the present embodiment, the complementary portion of the content is acquired from the distribution server 1300 in the distribution period based on the distribution schedule information 905c in the download control information 905 while the missing portion of the content is complemented by the acquired complementary portion. This enables the possibility that the missing portion of the content of the download program can be complemented to be increased. As a result, the user of the broadcast receiving apparatus 1200 can view the content having no missing portion.

### [2] Second Embodiment

A broadcast transmitting and receiving system according to a second embodiment will be described by referring to differences from the broadcast transmitting and receiving system 1000 according to the first embodiment.

A TLV multiplexer 1107 in the broadcast transmitting apparatus 1100 illustrated in FIG. 1 divides an MPEG-TS composing a content into units each having a size that is an integral multiple of the size of a TS packet (192 bytes or 188 bytes), and multiplexes each of the units obtained by the division on one TLV stream. Each of the units obtained by the division is referred to as a division unit. Let S be the size of the TS packet (hereinafter referred to as a TS packet size). The size of the division unit (hereinafter referred to as a division unit size) is (S×a) bytes, where “a” is an integer. Thus, the division unit of the MPEG-TS is multiplexed on each of the TLV streams extracted by the receiver 1201 in the broadcast receiving apparatus 1200. Therefore, the size of the AV stream separated from each of the TLV streams by the TLV demultiplexer 1203 is (S×a) bytes.

As described below, in complementary processing for a missing portion of the content, a distribution request start position and a distribution request size are respectively set to integral multiples of the TS packet size S. Thus, the complementary portion can be acquired in TS packet size units from the distribution server 1300.

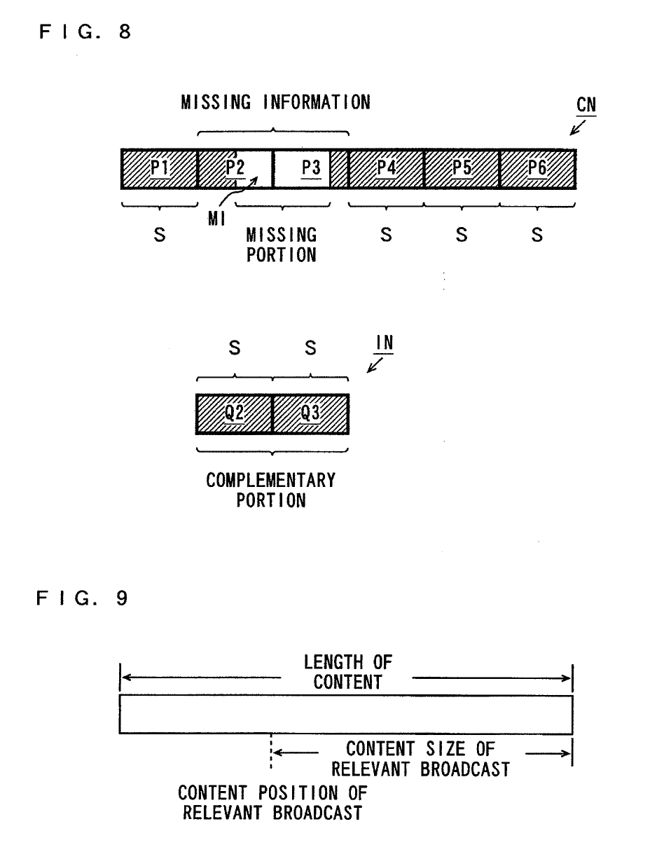

FIG. 8 illustrates a missing portion, missing information, and a complementary portion of a content in the second embodiment. As illustrated in FIG. 8, an ECG storage 1205 (see FIG. 1) in the broadcast receiving apparatus 1200 according to the present embodiment processes an AV stream composing a content CN in TS packet size units. More specifically, in step S6 (see FIG. 5) of download processing for a download program, an ECG storage 1205 stores an AV stream of a download program separated from a TLV stream by the TLV demultiplexer 1203 (see FIG. 1) in a content storage 1206 (see FIG. 1). In an example illustrated in FIG. 8, the content CN includes the six TS packets. In this example, packet numbers P1 to P6 are respectively assigned to six TS packets. The TS packet size of each of the TS packets is S.

In step S8 (see FIG. 5) of the download processing for the download program, the ECG storage 1205 stores, if a missing portion MI occurs in the content CN stored in the content storage 1206, a range of one or more TS packets including the missing portion MI of the content CN as missing information in TS packet size units. In the example illustrated in FIG. 8, missing portions MI respectively occur in a part of the TS packet with the packet number P2 and a part of the TS packet with the packet number P3. Therefore, the packet numbers P2 and P3 are stored as missing information in the content storage 1206.

Similarly, a download processor 1210 (see FIG. 1) in the broadcast receiving apparatus 1200 according to the present embodiment processes an AV stream composing a content CN in TS packet size units. More specifically, in step S17 (see FIG. 7) of complementary processing for the missing portion MI of the content CN, the download processor 1210 acquires a complementary portion IN of the content CN from the distribution server 1300 (see FIG. 1) in TS packet units. In the example illustrated in FIG. 8, two TS packets with packet numbers Q2 and Q3 corresponding to the two TS packets with the packet numbers P2 and P3 are respectively acquired as the complementary portion IN. In this case, the download processor 1210 sets a distribution request start position and a distribution request size to integral multiples of the TS packet size S, respectively. In the example illustrated in FIG. 8, the size of the complementary portion IN is two times the TS packet size. Therefore, the distribution request size is 2S bytes.

In step S18 (see FIG. 7) of the complementary processing for the missing portion MI of the content CN, a coupler 1212 (see FIG. 1) in the download processor 1210 couples the complementary portion IN of the content CN acquired from the distribution server 1300 to the missing portion MI of the content CN stored in the content storage 1206 in TS packet units. In the example illustrated in FIG. 8, the TS packets with the packet numbers P2 and P3 are respectively replaced with the TS packets with the packet numbers Q2 and Q3 so that the missing portion MI of the content CN stored in the content storage 1206 is complemented by the complementary portion IN of the content CN acquired from the distribution server 1300.

Thus, the ECG storage 1205 and the download processor 1210 process the AV stream composing the content CN in TS packet size units. Therefore, a number can be assigned to each of TS packets each including a missing portion. A number can be assigned to a TS packet including a complementary portion to correspond to the TS packet including the missing portion.

In this case, the packet number is designated so that a range of the missing portion of the content can be easily designated while the TS packet including the complementary portion can be easily acquired. The TS packet including the missing portion of the content stored in the content storage 1206 is replaced with the TS packet including the complementary portion of the content acquired from the distribution server 1300 so that the missing portion of the content can be easily complemented. Further, an algorithm for designating the range of the missing portion of the content and performing complementary processing for the missing portion of the content can be simplified.

In the complementary processing for the missing portion of the content, the distribution request start position and the distribution request size may be respectively set to integral multiples of the division unit size. More specifically, the distribution request start position is set to (S×a×b) bytes, where “b” is an integer. The distribution request size is set to (S×a×c) bytes, where “c” is an integer.

In this case, the ECG storage 1205 can detect the missing portion in TLV stream units. The download processor 1210 can acquire the complementary portion in TLV stream units. Thus, the algorithm for performing the complementary processing for the missing portion of the content can be further simplified.

### [3] Third Embodiment

A broadcast receiving apparatus according to a third embodiment will be described by referring to differences from the broadcast receiving apparatus 1200 according to the first embodiment.

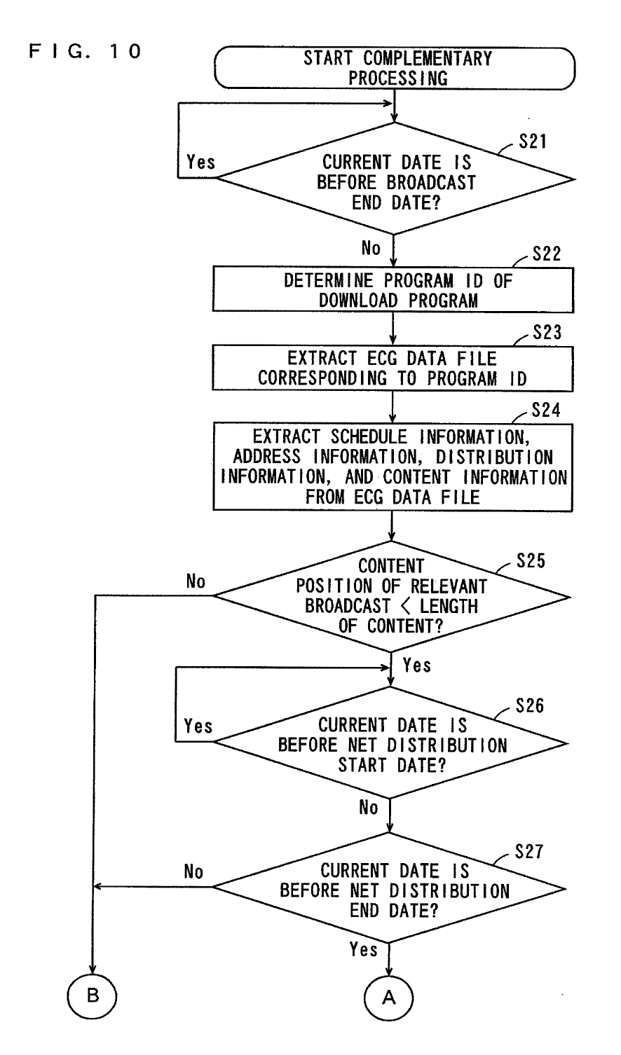

FIG. 9 is a diagram for illustrating content information 905d illustrated in FIG. 3. As illustrated in FIG. 9, a value of a content position of a relevant broadcast included in the content information 905d corresponds to the size of a portion, in which broadcast-type download broadcasting is completed, of a content. A value of a content size of the relevant broadcast included in the content information 905d represents the size of a portion, in which broadcast-type download broadcasting is not completed, of the content. The sum of the value of the content position of the relevant broadcast and the value of the content size of the relevant broadcast is equal to a value of the length of the content included in address information 905b.

In processing for reserving downloading of a download program illustrated in FIG. 5, before the content is stored in a content storage 1206 (steps S1 to S5), the value of the content position of the relevant broadcast is zero, and the value of the content size of the relevant broadcast is equal to the value of the length of the content. When the content starts to be stored in the content storage 1206 (steps S6 to S9), the value of the content position of the relevant broadcast is increased, and the value of the content size of the relevant broadcast is decreased. When the storage of the content is completed, the value of the content position of the relevant broadcast becomes equal to the value of the length of the content, and the value of the content size of the relevant broadcast becomes zero.

A download time of the download program depends on the size of the content and the transfer rate of digital broadcasting. If the size of the content of the download program is large or if the transfer rate of the digital broadcasting is low, therefore, all contents may be unable to be downloaded before the broadcast end date of the download program, and the download processing may end with the content downloaded halfway.

The download processor 1210 in the broadcast receiving apparatus 1200 according to the present embodiment processes, when download processing for a download program ends with the advent of the broadcast end data with the ECG storage 1205 storing the content halfway, a remaining portion, which is not stored, of the content as a missing portion, acquires a portion (a complementary portion), which corresponds to the missing portion, of the content, and performs complementary processing for the missing portion of the content using the acquired complementary portion. The complementary processing for the missing portion of the content in the present embodiment will be described below.

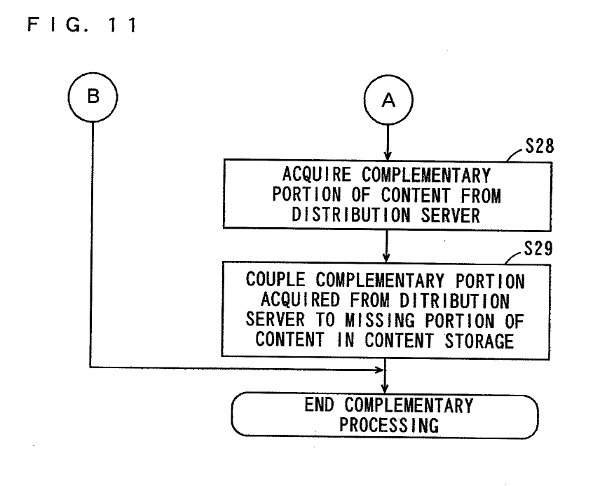

FIGS. 10 and 11 are flowcharts illustrating complementary processing for a missing portion of a content in the broadcast receiving apparatus 1200 according to the third embodiment. The complementary processing for the missing portion of the content in the present embodiment is performed after the download processing for the download program illustrated in FIG. 5.

The download processor 1210 determines whether the current date is before a broadcast end date included in broadcast schedule information 905a extracted in the download processing for the download program illustrated in FIG. 5 (step S21). If the current date is before the broadcast end date, the download processor 1210 waits until the current date reaches the broadcast end date. If the current date is after the broadcast end date, the download processor 1210 (see FIG. 1) determines a program ID 902a (see FIG. 3) of the download program (step S22).

The download processor 1210 then extracts an ECG data file 900 (see FIG. 3) corresponding to the program ID 902a from the ECG storage 1205 (see FIG. 1) (step S23). Then, the download processor 1210 extracts broadcast schedule information 905a, address information 905b, distribution schedule information 905c, and content information 905d (see FIG. 3) from the ECG data file 900 (step S24).

Then, the EPG storage 1204 determines whether a value of a content position of the relevant broadcast included in the content information 905d is smaller than a value of the length of a content included in the address information 905b (step S25). If the value of the content position is smaller than the value of the length of the content, a missing portion occurs in the content stored in the content storage 1206. Therefore, the download processor 1210 determines whether the current date is before a network distribution start date included in the distribution schedule information 905c (step S26).

If the current date is before the network distribution start date, the download processor 1210 waits until the current date reaches the network distribution start date. If the current date is after the network distribution start date, the download processor 1210 determines whether the current date is before a network distribution end date included in the distribution schedule information 905c (step S27). If the current date is before the network distribution end date, the download processor 1210 accesses the distribution server 1300 (see FIG. 1) based on the extracted address information 905b, and acquires at least the complementary portion of the content from the distribution server 1300 (step S28).

Then, the coupler 1212 (see FIG. 1) in the download processor 1210 couples the complementary portion of the content acquired from the distribution server 1300 to the missing portion of the content stored in the content storage 1206 (step S29). Thus, the missing portion of the content stored in the content storage 1206 is complemented. Then, the download processor 1210 ends the complementary processing for the missing portion of the content.

If the value of the content position is not less than the value of the length of the content in step S25, the missing portion does not occur in the content stored in the content storage 1206. Therefore, the download processor 1210 ends the complementary processing for the missing portion of the content.

Thus, in the download processing for the download program, if the download processing ends with the ECG storage 1205 storing the content halfway, the remaining portion of the content of the download program is complemented as a missing portion using the complementary portion acquired from the distribution server 1300 based on the content position of the relevant broadcast.

In the present embodiment, a portion, which is not stored at the time point where the download program finishes being broadcast, of the content can be easily determined based on the length of the content in the address information 905b and the content position of the relevant broadcast in the content information 905d.

As a result, the remaining portion of the content of the download program can be easily complemented as a missing portion, even when the download processing ends with the ECG storage 1205 storing the content halfway in the download processing for the download program because of the long broadcast time of the download program or the large size of the content.

If the current date is after the network distribution end date in step S27, the download processor 1210 cannot complement the missing portion of the content. Therefore, the download processor 1210 ends the complementary processing for the missing portion of the content. In this case, the download processor 1210 may indicate the missing portion of the content is not complemented on the video display device in a video/audio output unit 1209 (see FIG. 1). Thus, the user of the broadcast receiving apparatus 1200 can recognize that the missing portion exists in the content.

Alternatively, if the current date is after the network distribution end date in step S27, the download processor 1210 may wait until the content of the download program is distributed again from the distribution server 1300. In this case, if the content of the download program is not distributed again from the distribution server 1300 within a predetermined period, the download processor 1210 may indicate the missing portion of the content is not complemented on the video display device in the video/audio output unit 1209 (see FIG. 1).

### [4] Another Embodiment

(1) While the TLV multiplexing method is used as the download broadcast signal multiplexing method in the first to third embodiments, the present invention is not limited to this. Another multiplexing method may be used. In this case, a multiplexing method using a variable-length packet is preferably used to increase transmission efficiency.

(2) While the ECG storage 1205 performs the download processing for the download program in the first to third embodiments, the present invention is not limited to this. A control unit for performing the download processing for the download program may be separately provided in the broadcast receiving apparatus 1200 illustrated in FIG. 1.

(3) While the download processor 1210 performs the complementary processing for the missing portion of the content in the first to third embodiments, the present invention is not limited to this. A control unit for performing complementary processing for a missing portion of a content may be separately provided in the broadcast receiving apparatus 1200 illustrated in FIG. 1.

(4) While the download processor 1210 controls the receiver 1201 via the video/audio switching unit 1207 in the first to third embodiments, the present invention is not limited to this. The download processor 1210 may directly control the receiver 1201 without via the video/audio switching unit 1207.

(5) While the coupler 1212 is included in the download processor 1210 in the first to third embodiments, the present invention is not limited to this. The coupler 1212 may be provided outside the download processor 1210.

(6) While the content storage 1104 in the broadcast transmitting apparatus 1100 previously stores the content of the download program and the reproduction control information file 800 in the first to third embodiments, the present invention is not limited to this. The broadcast transmitting apparatus 1100 may separately have a reproduction control information storage, and the reproduction control information storage may previously store a reproduction control information file 800.

(7) While the content storage 1206 in the broadcast receiving apparatus 1200 stores as a content the AV stream separated by the TLV demultiplexer 1203 while storing the reproduction control information file 800 in the first to third embodiments, the present invention is not limited to this. The broadcast receiving apparatus 1200 may separately have a reproduction control information storage, and the reproduction control information storage may store a reproduction control information file 800 separated by the TLV demultiplexer 1203.

(8) While the broadcast transmitting apparatus 1100 separately has the content storage 1104 and the ECG data generator 1105 in the first to third embodiments, the present invention is not limited to this. The broadcast transmitting apparatus 1100 may have one storage, and the storage may store a content of a download program, a reproduction control information file 800, and an ECG data file 900.

(9) While the broadcast receiving apparatus 1200 separately has the ECG storage 1205 and the content storage 1206 in the first to third embodiments, the present invention is not limited to this. The broadcast receiving apparatus 1200 may have one storage, and the storage may store a content of a download program, a reproduction control information file 800, and an ECG data file 900.

(10) While the reproduction control information file 800 and the ECG data file 900 are transmitted from the broadcast transmitting apparatus 1100 to the broadcast receiving apparatus 1200 in the first to third embodiments, the present invention is not limited to this. For example, the reproduction control information file 800 and the ECG data file 900 may be distributed from the distribution server 1300 to the broadcast receiving apparatus 1200 via the Internet 1500.

(11) While the address information 905b includes the acquisition source URL of the content in the first to third embodiments, the present invention is not limited to this. For example, the address information 905b may include an acquisition source URI (Uniform Resource Identifier) of a content, a URN (Uniform Resource Name), or another address information representing an acquisition source of the content.

(12) In the first and second embodiments, the complementary processing for the missing portion of the content may be performed at timing set at random within a distribution period represented by the distribution schedule information 905c after the download processing for the download program. For example, the complementary processing for the missing portion of the content may be performed when the user of the broadcast receiving apparatus 1200 reproduces the content stored in the content storage 1206 to view the content within the distribution period.

When the signal level of the broadcast wave received by the broadcast receiving apparatus 1200 is decreased due to rainfall or the like, the missing portion may occur in the content recorded by a large number of users who live in the same area. In such a case, the large number of users are also prevented from simultaneously performing complementary processing for the missing portion of the content. Thus, a large number of broadcast receiving apparatuses 1200 are prevented from simultaneously accessing the distribution server 1300. As a result, a load on the distribution server 1300 can be reduced.

(13) While the complementary processing for the missing portion of the content stored in the content storage 1206 is performed when the missing portion occurs in the content due to the decrease in the signal level of the broadcast wave in the first and second embodiments, the present invention is not limited to this. If two download programs broadcast times of which overlap each other are downloaded, for example, the complementary processing for the missing portion of the content may be performed to acquire a portion, which corresponds to the overlapping broadcast time of the one download program, of the content.

In this case, the whole of the content of the one download program and a portion, which corresponds to the non-overlapping broadcast time of the other download program, of the content are acquired from the broadcast transmitting apparatus 1100, and a portion, which corresponds to the overlapping broadcast time of the other download program, of the content is acquired from the distribution server 1300. Thus, the contents of the two download programs the broadcast times of which overlap each other can be recorded.

(14) In the first and second embodiments, the download processor 1210 may acquire a portion, which corresponds to a first half of the download program, of the content from the broadcast transmitting apparatus 1100, and may acquire a portion, which corresponds to a latter half of the download program, of the content as a missing portion from the distribution server 1300. In this case, the portion of the content from the broadcast transmitting apparatus 1100 and the portion of the content from the distribution server 1300 are concurrently performed so that a time required until the download processing for the download program ends can be shortened. As a result, energy saving is implemented.

(15) In the third embodiment, the content position of the relevant broadcast in the content information 905d may be set to an integral multiple of the TS packet size or an integral multiple of the division unit size. In this case, the range of the missing portion of the content can be easily designated while the packet including the complementary portion can be easily acquired. The packet including the missing portion is replaced with the packet including the complementary portion so that the missing portion of the content can be easily complemented. Thus, an algorithm for complementing the missing portion of the content can be simplified.

(16) While the complementary portion of the content is acquired from the distribution server 1300 via the communication unit 1211 and the Internet 1500 in the first to third embodiments, the present invention is not limited to this. The complementary portion of the content may be acquired from the broadcast transmitting apparatus 1100 via the receiver 1201.

### [5] Correspondences Between Elements in the Claims and Parts in Embodiments

In the following paragraphs, non-limiting examples of correspondences between various elements recited in the claims below and those described above with respect to various preferred embodiments of the present invention are explained.

In the embodiment described above, the broadcast receiving apparatus 1200 is an example of a broadcast receiving apparatus, the AV stream is an example of a content, the distribution server 1300 is an example of a distribution server, the receiver 1201 is an example of a receiver, the TLV demultiplexer 1203 is an example of a separator, the ECG storage 1205 and the content storage 1206 are examples of a storage, the communication unit 1211 is an example of a communication unit, and the download processor 1210 is an example of a complementer.

The download control information 905 in the ECG data file 900 is an example of download control information, the broadcast schedule information 905a is an example of broadcast schedule information, the distribution schedule information 905c is an example of distribution schedule information, the period from the distribution start date to the distribution end date of the distribution schedule information 905c is an example of a distribution period, the content position of the relevant broadcast in the content information 905d is an example of a position of a corresponding portion in a content, the length of the content in the address information 905b is an example of a content size, and the address information 905b and the content information 905d are examples of the size of the acquisition content information.

The broadcast transmitting apparatus 1100 is an example of a broadcast transmitting apparatus, the TLV multiplexer 1107 is an example of a multiplexer, and the transmitter 1101 is an example of a transmitter.

As each of various elements recited in the claims, various other elements having configurations or functions described in the claims can be also used.

### INDUSTRIAL APPLICABILITY

The present invention is applicable to various types of audio-visual equipment capable of receiving download broadcasting.

1. A broadcast receiving apparatus configured to be capable of receiving a broadcast signal in broadcast-type download broadcasting while being connectable to a distribution server that stores a content of a program, comprising:
a receiver that receives a broadcast signal including the content of the program and download control information corresponding to the program;
a separator that separates the content of the program and the download control information from the broadcast signal received by said receiver;
a storage that stores the content and the download control information separated by said separator;
a communication unit that can access said distribution server; and
a complementer that acquires, when a missing portion exists in the content stored in said storage, a portion, which corresponds to said missing portion, of the content as a complementary portion from said distribution server by the communication unit accessing said distribution server, and complements said missing portion of the content using the acquired complementary portion,
wherein said download control information includes distribution schedule information representing a distribution period of the content by said distribution server, and
said complementer controls said communication unit to acquire the complementary portion corresponding to said missing portion in the distribution period represented by said distribution schedule information included in said download control information.

2. The broadcast receiving apparatus according to claim 1, wherein said complementer couples the complementary portion acquired from said distribution server to said missing portion of the content stored in said storage, to complement said missing portion of the content.

3. The broadcast receiving apparatus according to claim 1, wherein
the content stored in said storage includes a plurality of packets,
said complementer acquires one or a plurality of packets corresponding to one or a plurality of packets including said missing portion as a complementary portion from said distribution server by said communication unit, and replaces the one or plurality of packets including said missing portion with the acquired one or plurality of packets, to complement said missing portion of the content.

4. The broadcast receiving apparatus according to claim 1, wherein
said download control information further includes broadcast schedule information representing a broadcast time of a program in the broadcast-type download broadcasting, and
said complementer determines, when the storage of the content of the program in the storage is not completed within said broadcast time represented by the broadcast schedule information, a portion, which is not stored as said missing portion.

5. The broadcast receiving apparatus according to claim 1, wherein
said download control information further includes acquisition content information stored in said storage to respectively correspond to a plurality of portions of the content stored in said storage and each representing a position of a corresponding portion in the content and the size of the content, and
said complementer determines whether the portion, which is not stored in said storage, of the content exists based on said acquisition content information included in said download control information at the time point where the program in the broadcast-type download broadcasting finishes being broadcast, and determines, when the portion, which is not stored in said storage, exists, the portion that is not stored in said storage as said missing portion.

6. The broadcast receiving apparatus according to claim 5, wherein said complementer determines, when a value of the position of the corresponding portion in the content is smaller than a value of the size of the content at the time point where the program in the broadcast-type download broadcasting finishes being broadcast, a region from the position of the corresponding portion in the content to a final portion of the content as said missing portion.

7. A broadcast receiving method, comprising the steps of:
receiving a broadcast signal including a content of a program and download control information corresponding to the program;
separating the content of the program and the download control information from said received broadcast signal;
storing the separated content and download control information;
accessing a distribution server storing the content of the program when a missing portion exists in said stored content, to acquire a portion, which corresponds to said missing portion, of the content as a complementary portion from said distribution server; and
complementing said missing portion of the content using said acquired complementary portion,
wherein said download control information includes distribution schedule information representing a distribution period of the content by said distribution server, and
said acquiring step includes the step of acquiring the complementary portion corresponding to said missing portion in the distribution period represented by said distribution schedule information included in said download control information.

8. The broadcast receiving method according to claim 7, wherein
said storing step includes the step of storing a content including a plurality of packets,
said acquiring step includes the step of acquiring one or a plurality of packets corresponding to one or a plurality of packets including said missing portion as a complementary portion from said distribution server, and
said complementing step includes the step of replacing the one or plurality of packets including said missing portion with said acquired one or plurality of packets, to complement said missing portion of the content.

9. The broadcast receiving method according to claim 7, wherein
said download control information further includes broadcast schedule information representing a broadcast time of a program in broadcast-type download broadcasting, and
said complementing step includes the step of determining, when the storage of the content of the program is not completed within said broadcast time represented by the broadcast schedule information, the portion that is not stored as said missing portion.

10. The broadcast receiving method according to claim 7, wherein said download control information further includes acquisition content information stored to respectively correspond to a plurality of portions of said stored content and each representing a position of the corresponding portion in the content and the size of the content, and further comprising the step of
determining whether the portion, which is not stored, of the content exists based on said acquisition content information included in said download control information at the time point where the program in the broadcast-type download broadcasting finishes being broadcast, and determining, when the portion, which is not stored, exists, the portion that is not stored as said missing portion.

11. The broadcast receiving method according to claim 10, wherein
said acquiring step includes the step of determining, when a value of the position of the corresponding portion in the content is smaller than a value of the size of the content at the time point where the program in the broadcast-type download broadcasting finishes being broadcast, a region from a position of the corresponding portion in the content to a final portion of the content as said missing portion.

12. A broadcast transmitting apparatus that transmits a broadcast signal in broadcast-type download broadcasting, comprising:
a multiplexer that multiplexes a content of a program and download control information corresponding to the program on said broadcast signal; and
a transmitter that transmits the broadcast signal after the multiplexing by said multiplexer,
wherein said download control information includes distribution schedule information representing a distribution period of the content by a distribution server storing the content of said program.
